(19) United States
(12) Patent Application Publication
(10) Pub. No.: US 2006/0274056 A1
(43) Pub. Date: Dec. 7, 2006

(54) Methods and apparatus for operating optical sensors

(76) Inventors: Rani Ramamoorthy Saravanan, Singapore (SG); Soon Lee Tan, Singapore (SG); Kai Koon Lee, Singapore (SG); Kok Soon Yeo, Singapore (SG)

Correspondence Address: AVAGO TECHNOLOGIES, LTD., P.O. BOX 1920, DENVER, CO, 80201-1920, US

(21) Appl. No.: 11/141,919

(22) Filed: Jun. 1, 2005

(51) Int. Cl. G09G 5/00

(52) U.S. Cl. 345/175

(57) ABSTRACT

In a method for operating a plurality of optical sensors, each of the optical sensors is sequentially coupled to a shared input of a receiver. When electrically coupling a given one of the optical sensors to the shared input, at least one other of the optical sensors is shunted to ground. Apparatus that may be used to implement the method is provided with a plurality of optical sensors, and a receiver having a shared input. Each of a first plurality of switches couples one of the optical sensors to the shared input of the receiver. Each of a second plurality of switches shunts one of the optical sensors to ground.

### BACKGROUND OF THE INVENTION

Optical touch pads are commonly used in personal digital assistants (PDAs), medical instrumentation panels, and a variety of other hand-held and/or interactive devices. Typically, optical touch pads comprise optical source/sensor pairs that form intersecting light paths over the touch pad. By detecting blocked and unblocked ones of the light paths, touch pad touches may be detected.

### SUMMARY OF THE INVENTION

In one embodiment, a method for operating a plurality of optical sensors comprises: 1) sequentially coupling each of the optical sensors to a shared input of a receiver; and 2) when electrically coupling a given one of the optical sensors to the shared input, shunting at least one other of the optical sensors to ground.

In another embodiment, apparatus comprises a plurality of optical sensors, and a receiver having a shared input. Each of a first plurality of switches couples one of the optical sensors to the shared input of the receiver. Each of a second plurality of switches shunts one of the optical sensors to ground.

Other embodiments are also disclosed.

### BRIEF DESCRIPTION OF THE DRAWINGS

Illustrative embodiments of the invention are illustrated in the drawings in which:

FIG. 1 illustrates an exemplary method for operating optical sensors;

FIGS. 2-4 illustrate exemplary sequential states of exemplary apparatus for operating optical sensors; and

FIG. 5 illustrates an optical touch pad employing the apparatus shown in FIG. 2.

### DETAILED DESCRIPTION

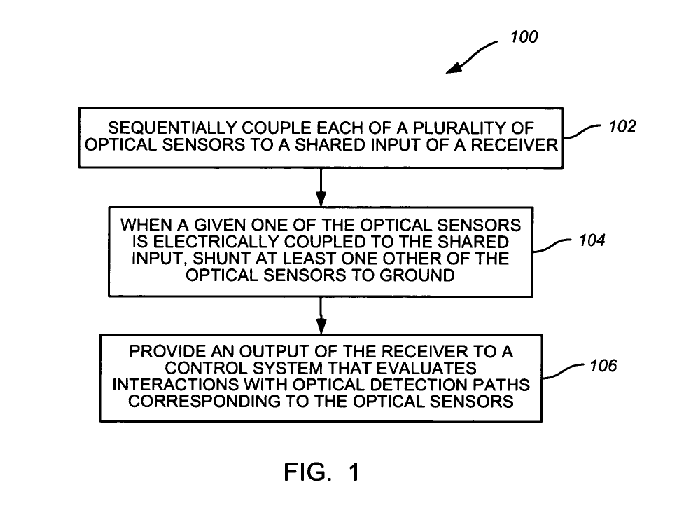

FIG. 1 illustrates an exemplary method 100 for operating a plurality of optical sensors. In accordance with the method 100, each of the optical sensors is sequentially coupled 102 to a shared input of a receiver. When a given one of the optical sensors is electrically coupled to the shared input, at least one other of the optical sensors is shunted 104 to ground.

In one embodiment of the method 100, when a given optical sensor is electrically coupled to the shared input, all of the other optical sensors are shunted to ground. In another embodiment, at least those optical sensors that are adjacent the given optical sensor are shunted to ground.

If each of the optical sensors corresponds to an optical detection path (such as an optical detection path of an optical touch pad), then the method 100 may further comprise providing 106 an output of the receiver to a control system that evaluates interactions with the optical detection paths.

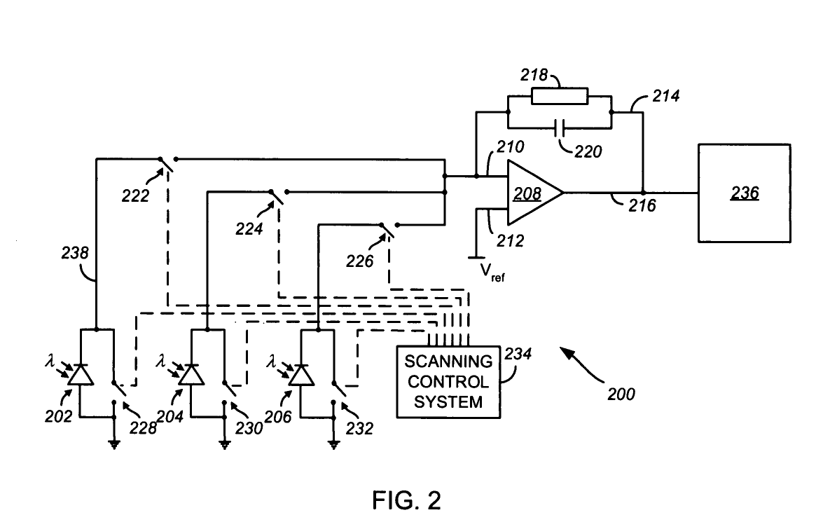

Exemplary apparatus 200 that may be used to implement the method 100 is shown in FIG. 2. The apparatus 200 comprises a plurality of optical sensors 202, 204, 206 (e.g., photodiodes, such as PIN diodes (as shown), or phototransistors) and a receiver 208 having a shared input 210. By way of example, the receiver 208 is shown to have another input 212 to which a reference voltage (Vref) is coupled, and a feedback path 214. By way of further example, the feedback path 214 may be coupled between the receiver's output 216 and shared input 210 and may comprise a resistance 218 coupled in parallel with a capacitance 220.

Each of a first plurality of switches 222, 224, 226 electrically couples one of the optical sensors 202, 204,206 to the shared input 210 of the receiver 208. Each of a second plurality of switches 228, 230, 232 shunts one of the optical sensors 202, 204, 206 to ground. The switches 222-232 may be variously implemented, but in one embodiment may take the form of field-effect transistor (FET) switches such as metal-oxide semiconductor FET (MOSFET) switches.

In one embodiment, the first and second pluralities of switches 222-232 are operated (e.g., opened and closed) by a scanning control system 234. By way of example, the scanning control system 234 may be programmed to sequentially close each of the first plurality of switches 222-226 (i.e., the “series switches) while opening others of the first plurality of switches, thereby coupling only one optical sensor to the shared input 210 at a time. In this manner, the state of each optical sensor 202-206 may be sequentially read by the receiver 208 and output to logic 236. In one embodiment, the logic 236 comprises latches or registers to store the sensor states output by the receiver 208.

Theoretically, and given that the optical sensors 202-206 are coupled to the shared input 210 sequentially, the receiver 208 should only read the state of one optical sensor at a time. However, depending on 1) the proximity of the optical sensors 202-206 to one another, and 2) whether multiple ones of the optical sensors 202-206 may be illuminated at the same time, there is a possibility of crosstalk between the optical sensors 202-206 and their associated signal paths. That is, even though an optical sensor is not coupled to the receiver 208, its illumination may cause it to induce a current in one or more other optical sensors. Thus, for example, if the switch 222 were closed to couple the optical sensor 202 to the receiver 208, but none of the other switches 224-232 were closed, stray or purposeful illumination of the optical sensor 204 might induce a current in signal path 238, which change could be interpreted as the optical sensor 202 being illuminated when, in fact, it is not.

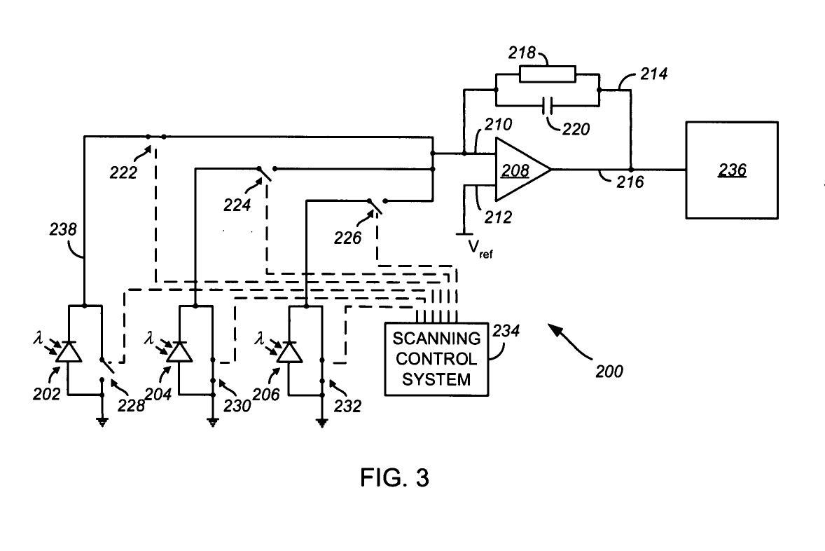

To reduce the likelihood of crosstalk between optical sensors 202-206, the scanning control system 234 may be programmed to operate the second plurality of switches 228-232 (i.e., the “shunt switches) by A) opening a shunt switch that is associated with an optical sensor that is coupled to the receiver 208, and B) closing at least one other shunt switch. See, for example, the state of the apparatus 200 shown in FIG. 3, where series switch 222 is closed while switches 224 and 226 are opened, and shunt switch 228 is opened while switches 230 and 232 are closed.

In one embodiment, the scanning control system 234 may close all of the shunt switches, but for the one which is associated with an “active” optical sensor (i.e., the one whose state is being read by the receiver 208). In another embodiment, only those of the shunt switches that are associated with optical sensors that are adjacent the “active” optical sensor are closed (since non-adjacent optical sensors are less likely to induce crosstalk between each other).

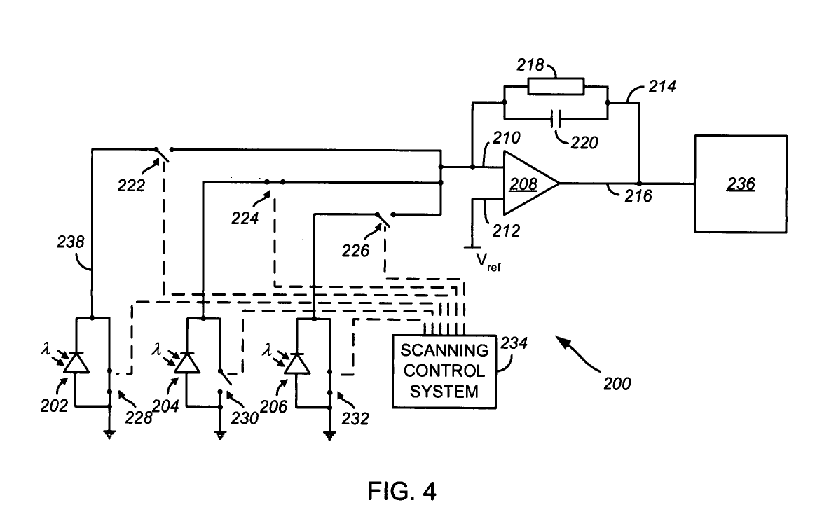

Following the state of the apparatus 200 shown in FIG. 3, the control system 234 might reconfigure the switches 222-232 in the states shown in FIG. 4, and so on.

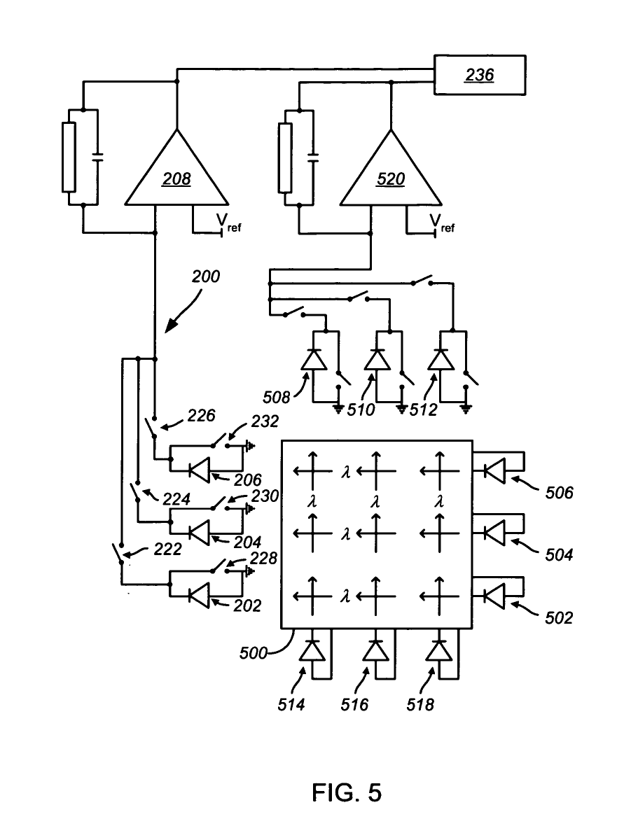

As shown in FIG. 5, one application of the apparatus 200 is in optical input detection. In such an application, the optical sensors 202-206 of the apparatus 200 are positioned on one side of an optical detection area 500 (e.g., a touch pad), and a plurality of optical sources 502, 504, 506 (e.g., light emitting diodes (LEDs)) are positioned on a side of the optical detection area 500 that is opposite the optical sensors 202-206. In this manner, each optical source 502-506 may illuminate a corresponding optical sensor 202-206 from across the optical detection area 500.

In one embodiment, the optical sources 502-506 may emit substantially collimated light beams. In another embodiment, the optical sources 502-506 may be sequentially activated by the scanning control system 234 such that each optical source 502-506 is activated at the same time that its corresponding optical sensor 202-206 is coupled to the receiver 208.

Additional optical sensors 508-512 and sources 514-518 may be positioned on the remaining edges of the optical detection area 500, with the sensors 508-512 being coupled to the receiver 208, or to another receiver 520 (as shown). The outputs of the receivers 208 and 520 may then both be coupled to the logic 236 so that the logic 236 can evaluate interactions with the optical detection area 500 (e.g., by determining the coordinates of touches made by a stylus or finger).

What is claimed is:

1. A method for operating a plurality of optical sensors, comprising:
sequentially coupling each of the optical sensors to a shared input of a receiver; and
when electrically coupling a given one of the optical sensors to the shared input, shunting at least one other of the optical sensors to ground.

2. The method of claim 1, wherein, when the given one of the optical sensors is electrically coupled to the shared input, at least optical sensors that are adjacent the given optical sensor are shunted to ground.

3. The method of claim 1, wherein, when the given one of the optical sensors is electrically coupled to the shared input, all of the other optical sensors are shunted to ground.

4. The method of claim 1, wherein each of the optical sensors corresponds to an optical detection path; the method further comprising, providing an output of the receiver to a control system that evaluates interactions with the optical detection paths.

5. An apparatus, comprising:
a plurality of optical sensors;
a receiver having a shared input;
a first plurality of switches, each of which electrically couples one of the optical sensors to the shared input of the receiver; and
a second plurality of switches, each of which shunts one of the optical sensors to ground.

6. The apparatus of claim 5, further comprising a scanning control system programmed to i) sequentially close each of the first plurality of switches while opening others of the first plurality of switches, and ii) when closing one of the first plurality of switches associated with a given optical sensor, A) opening one of the second plurality of switches associated with the given optical sensor, and B) closing at least one other of the second plurality of switches.

7. The apparatus of claim 6, wherein, when the scanning control system opens the one of the second plurality of switches associated with the given optical sensor, the scanning control system closes all of the others of the second plurality of switches.

8. The apparatus of claim 6, wherein, when the scanning control system opens the one of the second plurality of switches associated with the given optical sensor, the scanning control system closes at least those of the second plurality of switches that are associated with optical sensors adjacent the given optical sensor.

9. The apparatus of claim 6, further comprising:
a touch pad; and
a plurality of optical light emitting diodes (LEDs);
wherein the plurality of optical sensors are photodiodes; and
wherein each LED illuminates a corresponding optical sensor from across the touch pad.

10. The apparatus of claim 5, further comprising:
an optical detection area; and
a plurality of optical sources;
wherein each optical source illuminates a corresponding optical sensor from across the optical detection area.

11. The apparatus of claim 10, wherein the optical detection area comprises a touch pad.

12. The apparatus of claim 10, further comprising logic, coupled to an output of the receiver, to evaluate interactions with the optical detection area.

13. The apparatus of claim 5, wherein the first and second pluralities of switches comprise field-effect transistor switches.

14. The apparatus of claim 5, wherein the first and second pluralities of switches comprise metal-oxide semiconductor field-effect transistor (MOSFET) switches.

15. The apparatus of claim 5, wherein the plurality of optical sensors are photodiodes.

16. The apparatus of claim 5, wherein the plurality of optical sources are light emitting diodes (LEDs).
